(19) United States
(12) Patent Application Publication
(10) Pub. No.: US 2017/0083178 A1
(43) Pub. Date: Mar. 23, 2017

(54) SYSTEMS AND METHODS FOR IMPLEMENTING IMPROVED INTERACTIVE CALENDAR FOR MOBILE DEVICES

(71) Applicant: Limited Liability Company Mail.Ru, Moscow (RU)

(72) Inventors: Alexander Sergeevich KIROV, Electrostal (RU); Yury Alexandrovich VETROV, Moscow (RU)

(21) Appl. No.: 15/190,205

(22) Filed: Jun. 23, 2016

Related U.S. Application Data
(63) Continuation of application No. PCT/RU2013/001203, filed on Dec. 30, 2013.

(51) Int. Cl. G06F 3/0482; G06F 3/0485; G06Q 10/10; G06F 3/0488

(52) U.S. Cl. CPC G06F 3/0482; G06F 3/04883; G06F 3/0485; G06Q 10/1093

(57) ABSTRACT

Method involves generating a graphical user interface on a display device, the user interface including a calendar portion comprising multiple calendar date elements, the plurality of calendar date elements being horizontally arranged on the display device wherein at least some of the calendar date elements comprise a user availability indicator indicating an availability of a user during a corresponding day; receiving information on a user interaction event in connection with the calendar portion of the user interface; if the user interaction event is a selection event performed in connection with a first calendar date element of the plurality of calendar date elements, displaying calendar events corresponding to the first calendar date element; and if the user interaction event is a vertical swipe gesture, generating a second user interface comprising a second calendar portion, the second calendar portion comprising a second plurality of calendar date elements corresponding to calendar month.

### BACKGROUND OF THE INVENTION

Technical Field

The disclosed embodiments relate in general to graphical user interfaces of electronic computing devices and, more specifically, to systems and methods for implementing an improved interactive calendar for mobile devices.

Description of the Related Art

Conventional calendar graphical user interfaces suffer from a number of drawbacks. The most important of them is the need to open a separate calendar window or a web page, which unavoidably interferes with the current task performed by the user. While there exist calendar user interfaces that display dates in one-line arrangement, which is less obstructive on the computer display, the user interaction with these calendar interfaces is limited to date navigation. For example, the users are not allowed to drop items onto such calendars to create new calendar events and cannot view scheduled calendar events by any other means than clicking on the specific date, which opens a new calendar window with calendar information regarding that specific date. The users are also not able to judge how busy they are on the specific date by simply looking at the conventional horizontal calendars without having to click on each date separately.

The deficiencies of the conventional calendar interfaces are exacerbated in mobile applications running on mobile computing devices, where the display screens are more compact compared to the desktop computer systems. Therefore, new and improved techniques for implementing graphical user interfaces incorporating minimally obstructive interactive calendars for mobile devices are needed.

### SUMMARY OF THE INVENTION

The embodiments described herein are directed to methods and systems that substantially obviate one or more of the above and other problems associated with conventional techniques for implementing graphical user interfaces for calendars.

In accordance with one aspect of the inventive concepts described herein, there is provided a computer-implemented method for generating a calendar graphical user interface, the method being performed in connection with a computerized system including a processor, a memory and a display device, the method involving: generating a graphical user interface on the display device, the graphical user interface including a calendar portion, the calendar portion including multiple calendar date elements, wherein the multiple calendar date elements are horizontally arranged on the display device and wherein at least some of the calendar date elements include a user availability indicator indicating an availability of a user during a corresponding day; receiving information on a user interaction event in connection with the calendar portion of the user interface; if the received information indicates that the user interaction event is a selection event performed in connection with a first calendar date element of the multiple calendar date elements, displaying calendar events corresponding to the first calendar date element; and if the received information indicates that the user interaction event is a vertical swipe gesture, generating a second graphical user interface including a second calendar portion, the second calendar portion including a second multiple calendar date elements corresponding to a calendar month.

In one or more embodiments, the user availability indicator is color-coded based on the availability of the user during the corresponding day.

In one or more embodiments, the user availability indicator is color-coded with a color selected from a group consisting of: green, yellow and red colors.

In one or more embodiments, the graphical user interface includes an agenda portion and wherein the calendar events corresponding to the first calendar date element are displayed in the agenda portion.

In one or more embodiments, the method further involves, in response to detection of a scroll event in connection with the agenda portion, correspondingly scrolling the calendar date elements in the calendar portion.

In one or more embodiments, the calendar portion is positioned at the bottom of the graphical user interface.

In one or more embodiments, the calendar portion is semi-transparent.

In one or more embodiments, second graphical user interface further includes a statistical portion including calendar event statistical information for the calendar month.

In one or more embodiments, the calendar event statistical information includes information on numbers of calendar events of predetermined different types.

In one or more embodiments, the calendar event statistical information includes information on numbers of calendar events on predetermined weekdays.

In one or more embodiments, the information on numbers of calendar events on predetermined weekdays includes multiple color-coded bars.

In accordance with another aspect of the inventive concepts described herein, there is provided a non-transitory computer-readable medium embodying a set of computer-readable instructions, which, when executed in connection with a computerized system including a processor, a memory and a display device, cause the computerized system to perform a method for generating a calendar graphical user interface, the method involving: generating a graphical user interface on the display device, the graphical user interface including a calendar portion, the calendar portion including multiple calendar date elements, wherein the multiple calendar date elements are horizontally arranged on the display device and wherein at least some of the calendar date elements include a user availability indicator indicating an availability of a user during a corresponding day; receiving information on a user interaction event in connection with the calendar portion of the user interface; if the received information indicates that the user interaction event is a selection event performed in connection with a first calendar date element of the multiple calendar date elements, displaying calendar events corresponding to the first calendar date element; and if the received information indicates that the user interaction event is a vertical swipe gesture, generating a second graphical user interface including a second calendar portion, the second calendar portion including a second multiple calendar date elements corresponding to a calendar month.

In one or more embodiments, the user availability indicator is color-coded based on the availability of the user during the corresponding day.

In one or more embodiments, the user availability indicator is color-coded with a color selected from a group consisting of: green, yellow and red colors.

In one or more embodiments, the graphical user interface includes an agenda portion and wherein the calendar events corresponding to the first calendar date element are displayed in the agenda portion.

In one or more embodiments, the method further involves, in response to detection of a scroll event in connection with the agenda portion, correspondingly scrolling the calendar date elements in the calendar portion.

In one or more embodiments, the calendar portion is positioned at the bottom of the graphical user interface.

In one or more embodiments, the calendar portion is semi-transparent.

In one or more embodiments, second graphical user interface further includes a statistical portion including calendar event statistical information for the calendar month.

In one or more embodiments, the calendar event statistical information includes information on numbers of calendar events of predetermined different types.

In one or more embodiments, the calendar event statistical information includes information on numbers of calendar events on predetermined weekdays.

In one or more embodiments, the information on numbers of calendar events on predetermined weekdays includes multiple color-coded bars.

In accordance with yet another aspect of the inventive concepts described herein, there is provided a computerized system comprising a processor, a memory and a display device, the memory storing a set of computer-readable instructions, which, when executed by the processor cause the computerized system to perform a method for generating a calendar graphical user interface, the method involving: generating a graphical user interface on the display device, the graphical user interface including a calendar portion, the calendar portion including multiple calendar date elements, wherein the multiple calendar date elements are horizontally arranged on the display device and wherein at least some of the calendar date elements include a user availability indicator indicating an availability of a user during a corresponding day; receiving information on a user interaction event in connection with the calendar portion of the user interface; if the received information indicates that the user interaction event is a selection event performed in connection with a first calendar date element of the multiple calendar date elements, displaying calendar events corresponding to the first calendar date element; and if the received information indicates that the user interaction event is a vertical swipe gesture, generating a second graphical user interface including a second calendar portion, the second calendar portion including a second multiple calendar date elements corresponding to a calendar month.

In one or more embodiments, the user availability indicator is color-coded based on the availability of the user during the corresponding day.

In one or more embodiments, the user availability indicator is color-coded with a color selected from a group consisting of: green, yellow and red colors.

In one or more embodiments, the graphical user interface includes an agenda portion and wherein the calendar events corresponding to the first calendar date element are displayed in the agenda portion.

In one or more embodiments, the method further involves, in response to detection of a scroll event in connection with the agenda portion, correspondingly scrolling the calendar date elements in the calendar portion.

In one or more embodiments, the calendar portion is positioned at the bottom of the graphical user interface.

In one or more embodiments, the calendar portion is semi-transparent.

In one or more embodiments, second graphical user interface further includes a statistical portion including calendar event statistical information for the calendar month.

In one or more embodiments, the calendar event statistical information includes information on numbers of calendar events of predetermined different types.

In one or more embodiments, the calendar event statistical information includes information on numbers of calendar events on predetermined weekdays.

In one or more embodiments, the information on numbers of calendar events on predetermined weekdays includes multiple color-coded bars.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a calendar graphical user interface generated on a display of a mobile computing device by one or more embodiments of a calendar application described herein.

FIG. 2 illustrates in detail an exemplary structure of an embodiment of the date elements.

FIG. 3 illustrates another exemplary embodiment of a calendar user interface of a mobile computing device.

FIG. 4 illustrates yet another exemplary embodiment of a calendar user interface of a mobile computing device.

FIG. 5 illustrates yet another exemplary embodiment of a calendar user interface of a mobile computing device.

FIG. 6 illustrates yet another exemplary embodiment of a calendar user interface of a mobile computing device.

FIG. 7 illustrates a further exemplary embodiment of a calendar user interface of a mobile computing device.

FIG. 8 illustrates an exemplary operating sequence of an embodiment of the described calendar application.

FIG. 9 is a block diagram that illustrates an exemplary embodiment of the mobile computerized system on which an embodiment of the described calendar application may be deployed.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one or more embodiments described herein, there is provided a computerized system and an associated computer-implemented method and computer-readable medium for implementing an improved interactive calendar user interface for deployment on mobile devices. In various implementations, the graphical user interfaces described herein may be implemented as a part of a mobile application written using Objective-C, Java or any other suitable programming language. In one or more embodiments, the functionality described herein may be deployed in a stand-alone application executing on a computing device, such as a smartphone or a tablet computer.

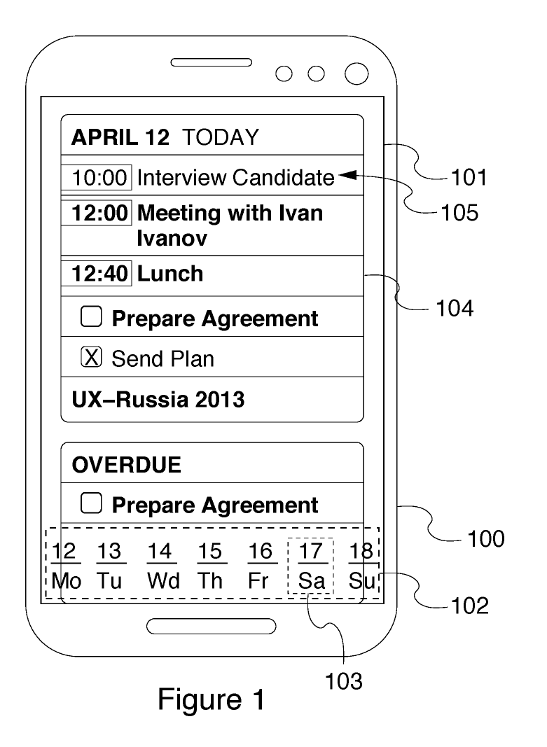

FIG. 1 illustrates an exemplary embodiment of a user interface 101 of a mobile computing device 100 incorporating a calendar portion 102, generated by one or more embodiments of a calendar application described herein. In one embodiment, the calendar portion 102 is displayed at the bottom of the graphical user interface 101. The calendar portion 102 includes a plurality of horizontally arranged date elements 103, each representing a different calendar date. As would be appreciated by those of skill in the art, because the date elements 103 of the calendar portion 102 are horizontally arranged, the calendar portion 102 occupies a very small (stripe-shaped) portion at the bottom of the user interface 101 without creating an excessive obstruction for other content displayed by the user interface 101. In one or more embodiments, the aforesaid date elements are sequentially arranged left-to-right. In one or more embodiments, the calendar portion 102 displays seven date elements 103 corresponding to seven days of the week. In one embodiment, by default, the days a current week are displayed to the user. I one or more embodiments, the calendar portion 102 with date elements 103 is only partially occluding the underlying content displayed on the graphical user interface 101. In other words, the calendar portion 102 is semi-transparent allowing user to at least partially see the underlying content.

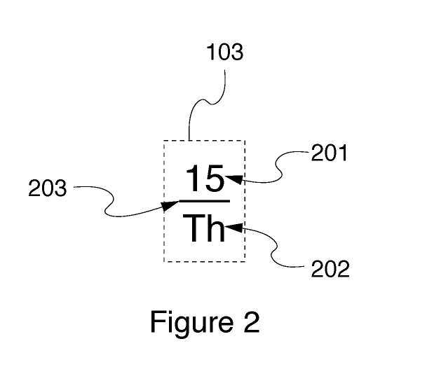

FIG. 2 illustrates in more detail an exemplary structure of an embodiment of the date elements 103. As shown in FIG. 2, each date element 103 includes a top portion 201 displaying the day of the month (15th in the example shown in FIG. 2) as well as a bottom portion 202 displaying the corresponding day of the week (Thursday in the example shown in FIG. 2). In one or more embodiment, the date element 103 may also include an availability indicator 203, which may be implemented in a form of a thin color-coded bar displayed between the top portion 201 and the bottom portion 202 of the date element 103. In one or more embodiments, the color of the user availability indicator represents the user's general availability during the respective date. For example, green availability indicator may indicate that the user's schedule is generally open. Yellow availability indicator indicates that the user may have limited availability during the respective date. Finally, red availability indicator indicates that the user is not available on the particular date. The color of the availability indicator may be determined by the calendar application by comparing number and/or duration of user's availability periods during the day with a predetermined set of thresholds. In an alternative embodiment, the number or duration of the user's scheduled events during the day may be compared with a predetermined set of thresholds. Each threshold would corresponds a predetermined color code. In one embodiment, red color of the availability indicator indicates that more than 65% of user's available time during the day is occupied with tasks. Yellow color of the indicator may indicate that more than 35% but less than 65% of user's available time during the day is occupied with tasks. Finally, green indicator shows that less than 35% of user's available time during the day is so occupied. The absence of color-coded availability indicator indicates that the corresponding day is entirely open.

As would be appreciated by those of skill in the art, using the colored availability indicator 203 the user may quickly get an idea about his or her availability during a particular day without having to open the entire schedule for that day and without having to interrupt user's current task. In one or more embodiments, date elements 103 provided in the calendar portion 102 may correspond to a different time period than a week shown in the above example.

Going back to FIG. 1, the embodiment of the user interface 101 shown in that figure may additionally include an agenda portion 104 showing separate calendar events 105 placed on user's calendar on a particular date. In one or more embodiments, the events that have already taken place can be blurred by the calendar application. The agenda portion 104 of the user interface 101 may also include tasks such as “Prepare Agreement” that are to be completed on the specific date. The tasks that have been completed may be also be blurred.

In one or more embodiments, each date element 103 of the calendar portion 102 is user-interactive. When the user selects a particular date element 103, for example by tapping a finger on the respective date element 103 displayed on a touch-sensitive display of a mobile computing device, the calendar application is notified of the user's selection and displays the agenda for the selected date in the agenda portion 104. The displayed agenda may include all the events 105 scheduled for the user for the selected date. In one or more embodiments, the system is configured to display all information about each scheduled event without truncation. In the same or different embodiments, the system may display information about availability of the user on that date.

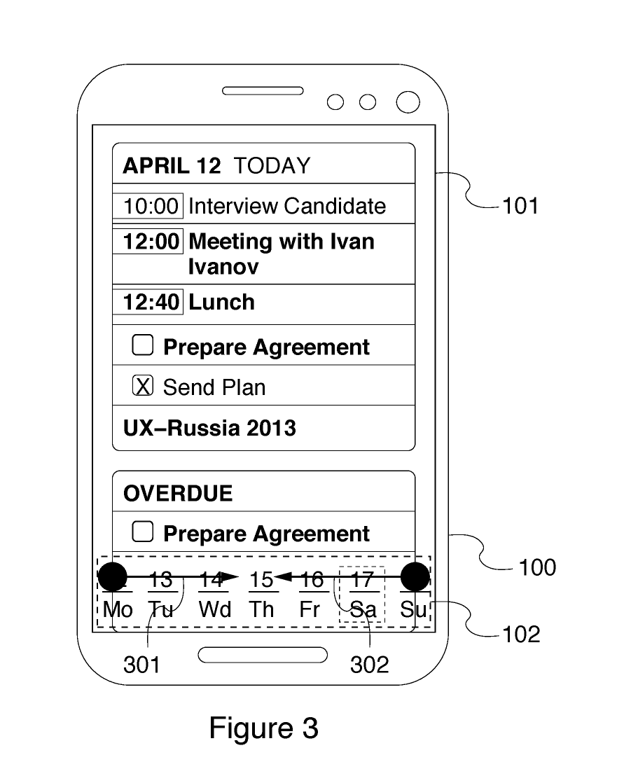

In one or more embodiments, the user is able to scroll the dates displayed in the calendar portion 102 by using horizontal swiping gestures illustrated in FIG. 3. Detection of the right swiping gesture 301 causes the calendar application to display the earlier dates (earlier than the previously displayed dates) and move the previously displayed dates to the right. Similarly, detection of the left swiping gesture 302 causes the calendar application to display the later dates (later than the previously displayed dates) and move the previously displayed dates to the left. The calendar events 105 displayed in the agenda portion 104 may be appropriately automatically updated when the date elements 103 in the calendar portion 102 are scrolled. Specifically, in one embodiment, the calendar events 105 displayed in the agenda portion 104 may correspond to the first date element 103 displayed in the calendar portion 102. In another, alternative, embodiment, the calendar events 105 displayed in the agenda portion 104 may correspond to the middle (fourth) date element 103 displayed in the calendar portion 102.

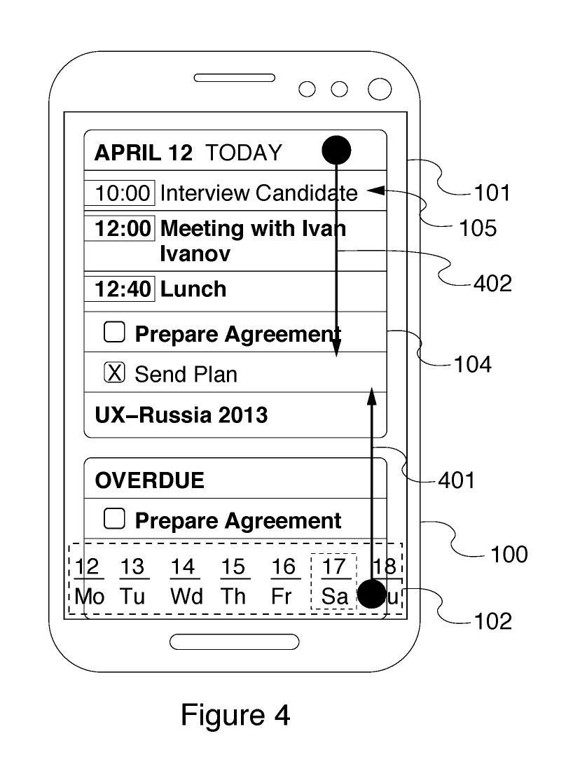

Similarly, when the information displayed in the agenda portion 104 is scrolled by the user to a different date, the date elements 103 in the calendar portion 102 may be correspondingly scrolled. For example, in the embodiment shown in FIG. 4, the user may use a vertical swiping gesture 402 to scroll the information displayed in the agenda portion 104. When the calendar application is notified of the user's vertical swiping gesture 402, it is configured to scroll the information displayed in the agenda portion 104 to a different (earlier or later) date. At the same time, the calendar application horizontally scrolls the date elements 103 displayed in the calendar portion 102 such that a predetermined date element 103 (for example first or fourth date element displayed in the calendar portion 102) corresponds to the date currently displayed in the agenda portion 104.

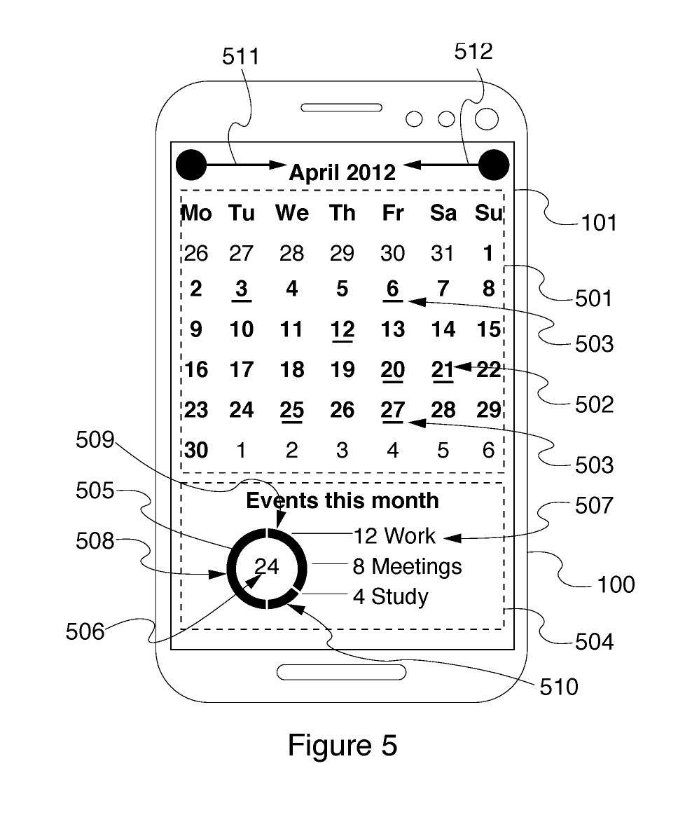

In one or more embodiments, upon the detection of the user's upward swiping gesture 401 shown in FIG. 4, the calendar application is configured to display a monthly calendar user interface shown in FIG. 5. In one or more embodiments, the gesture 401 originates at the bottom of the screen of the mobile computing device 100 and extends vertically in the upward direction.

With reference to FIG. 5, monthly calendar user interface includes a monthly calendar portion 501 showing date elements 502 corresponding to all dates of the selected calendar month as well as a statistical portion 504 located below the monthly calendar portion 501. In one or more embodiments, color-coded availability indicators 503 described in detail above may be displayed below the date elements 502 to provide quick visual indication of the availability of the user on the specific date.

The statistical portion 504 may include a diagram 505 showing types of events appearing on user's calendar during the respective month. In one or more embodiments, the diagram 505 is implemented in a form of a circle subdivided into two or more segments each corresponding to a particular calendar event type. For example, a first circle segment 508 may correspond to work events, second circle segment 509 may correspond to meetings and the third circle segment 510 may correspond to study events. In one or more embodiments, the lengths of the corresponding circle segments are proportional to the numbers of the respective calendar events shown to the right of the diagram as indicated by the numeral 507. The total number of all calendar events 506 in the given month may be displayed in the center of the diagram 505. In one or more embodiments, the aforesaid diagram 505 may be color-coded with segments corresponding to different types of calendar events being coded with different colors, which may correspond to the colors of the event types and numbers 507. In one or more embodiments, the diagram 505 and the associated information 507 may be animated (dynamic).

In one or more embodiments, upon the detection of the user's right horizontal swiping gesture 511 shown in FIG. 5, the calendar application is configured to display the monthly calendar user interface for a previous month. Similarly, upon the detection of the user's left horizontal swiping gesture 512, the calendar application is configured to display the monthly calendar user interface for a subsequent month. As would be appreciated by persons of ordinary skill in the art, this feature provides the user with a simple and intuitive monthly calendar navigation capability.

In one or more embodiments, the calendar graphical user interface may incorporate one or more additional date navigational elements (not shown), such as arrows positioned within the monthly calendar user interface. These elements enable the user to quickly move to a view displaying different months of the year on the calendar. When the user activates the additional navigational elements, the calendar displays previous or subsequent month. Finally, when the user selects a specific date element on the monthly calendar user interface shown in FIG. 5, the calendar application is configured to go back to the user interface shown in FIG. 1 and display detailed agenda including calendar events 104 for the selected date. In one or more embodiments, the same action may be triggered by performing a vertical downward gesture originating at the top of the screen of the mobile computing device 100.

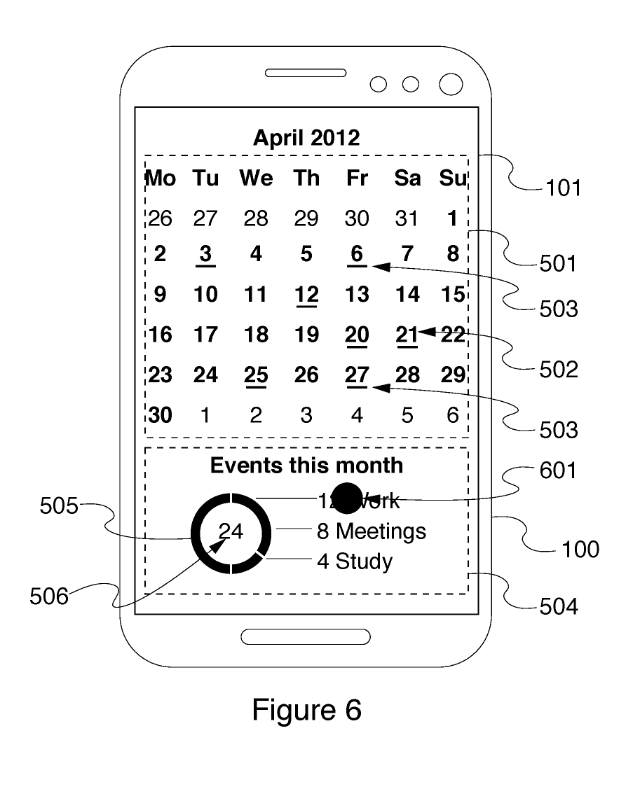

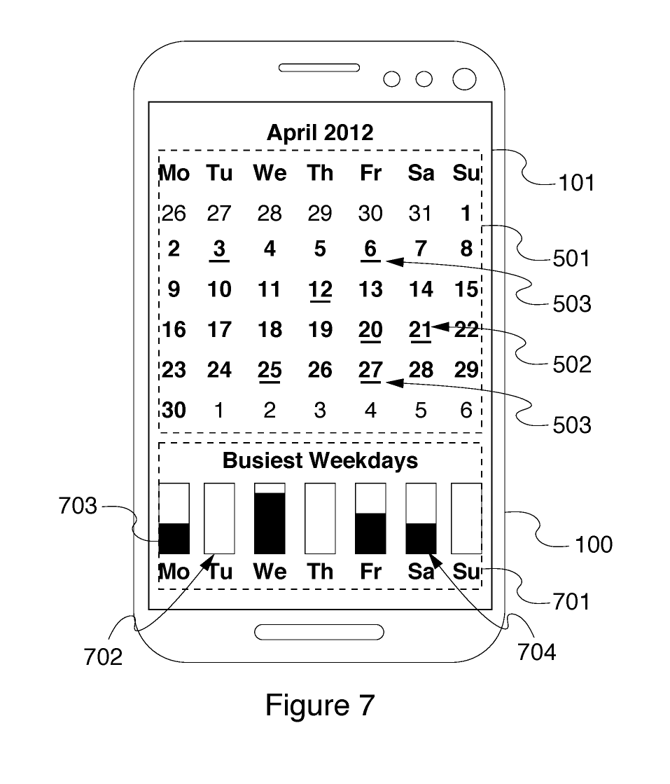

When the calendar application detects that the user has touched inside the statistical portion 504 of the monthly calendar user interface, as indicated by a numeral 601 in FIG. 6, the calendar application displays the embodiment of the user interface shown in FIG. 7. In that figure, the statistical portion 701 displays information on the busiest days of the week and includes a number of vertical bars graphs 702 each corresponding to a different day of the week, which is indicated below the respective bar graph. The filled portion 703 or 704 of the respective bar graph 702 represents the degree of workload of the user on the specific day of the week averaged during the respective month. The higher is the filled portion 703, the more busy is the user (on average) during the respective day of the week. In addition, the filled portion 703 may be color-coded in a similar manner to the color-coding of the user availability indicator 203 described in detail above. For example, the filled portion 703 or 704 may be color-coded in green because the user is only moderately busy on the respective days.

As would be appreciated by those of ordinary skill in the art, the described examples of color-coding, layouts of various elements of the calendar user interface and the gestures used to navigate the various embodiments of the calendar user interface are exemplary only and should not be construed in the limiting sense.

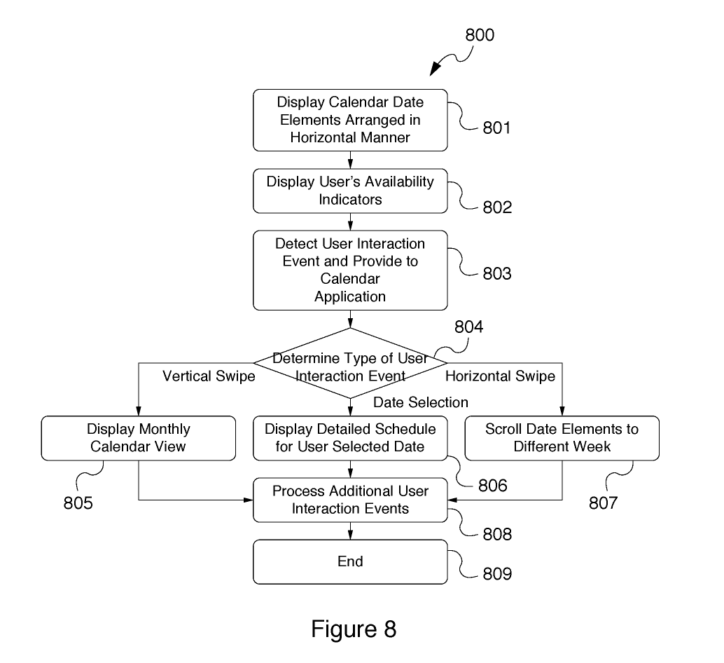

FIG. 8 illustrates an exemplary operating sequence 800 of an embodiment of the described calendar application. At step 801, the calendar application displays the calendar date elements on the display device arranged in a horizontal manner. At step 802, the color-coded user availability indicators are displayed within the respective date elements. At step 803, the user interaction event is detected and provided to the calendar application. The type of user interaction event is determined in step 804. If the detected user interaction event is a vertical swipe gesture starting at the bottom of the screen, then at step 805 a monthly calendar user interface is displayed, as shown, for example, in FIG. 5.

If the detected event is a date selection event, then at step 806, the calendar events 105 for the selected dates are displayed in the agenda portion 104 of the user interface 101 as shown, for example, in FIG. 1. Finally, if the event is a date navigation event, such as a horizontal swipe gesture, then at step 807 different date elements 103 are displayed in the calendar portion 102. Additional events are handled at step 808 and the operation terminates at step 809.

It should be noted that in one or more embodiments, the described calendar application may automatically generate reminders for the users of particular tasks that require user's attention, such as an upcoming or an over-due deadline. In one or more embodiments, the described calendar user interface may be incorporated into an electronic messaging application, such as email application. In one or more embodiments, the scheduled calendar events may be recurring events, such as a weekly meeting. Moreover, in one or more embodiments, the described calendar user interface is displayed to the user without interfering with the user's current context. To this end, the described calendar user interface may be displayed on the same screen as the user was on prior to the activation of the calendar application and/or the calendar interface may be displayed on only a portion of the device's screen leaving the remaining portion to other displayed content.

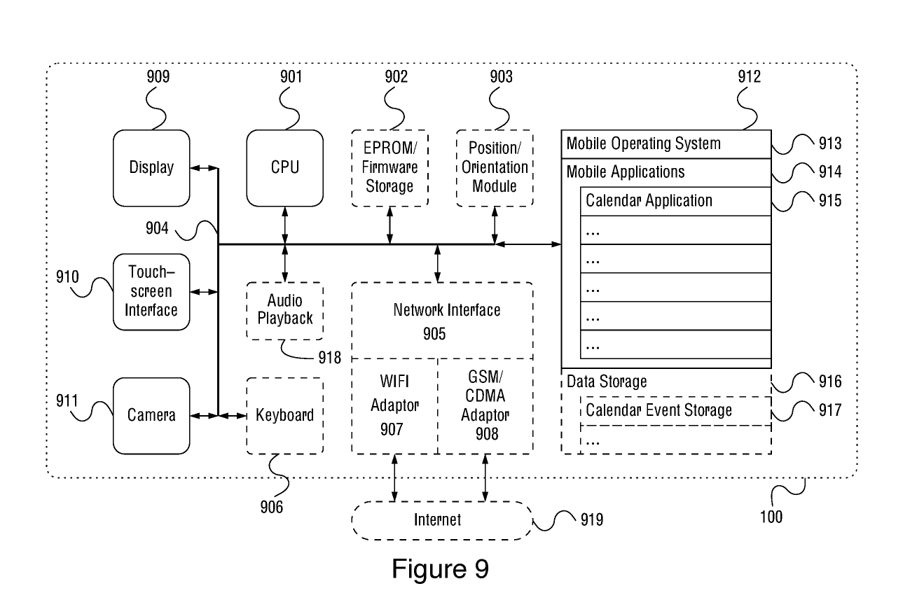

FIG. 9 is a block diagram that illustrates an exemplary embodiment of the mobile computerized system 100 (also referred to herein as “computerized system 100” or “mobile computing device 100”) on which an embodiment of the described calendar application may be deployed. In one or more embodiments, the computerized system 100 may be implemented within the form factor of a mobile computing device, such as a smartphone, a personal digital assistant (PDA), or a tablet computer, all of which are available commercially and are well known to persons of skill in the art. In an alternative embodiment, the computerized system 100 may be implemented based on a desktop, a laptop or a notebook computer. Yet in an alternative embodiment, the computerized system 100 may be an embedded system, incorporated into an electronic device with certain specialized functions, such as an electronic book (or e-book) reader. Yet in an alternative embodiment, the computerized system 100 may be implemented as a part of an augmented reality head-mounted display (HMD) systems, such as Google Glass, also well known to persons of ordinary skill in the art.

The computerized system 100 may include a data bus 904 or other interconnect or communication mechanism for communicating information across and among various hardware components of the computerized system 100, and a central processing unit (CPU or simply processor) 901 coupled with the data bus 904 for processing information and performing other computational and control tasks. Computerized system 100 also includes a memory 912, such as a random access memory (RAM) or other dynamic storage device, coupled to the data bus 904 for storing various information as well as instructions to be executed by the processor 901. The memory 912 may also include persistent storage devices, such as a magnetic disk, optical disk, solid-state flash memory device or other non-volatile solid-state storage devices.

In one or more embodiments, the memory 912 may also be used for storing temporary variables or other intermediate information during execution of instructions by the processor 901. Optionally, computerized system 100 may further include a read only memory (ROM or EPROM) 902 or other static storage device coupled to the data bus 904 for storing static information and instructions for the processor 901, such as firmware necessary for the operation of the computerized system 100, basic input-output system (BIOS), as well as various configuration parameters of the computerized system 100.

In one or more embodiments, the computerized system 100 may incorporate a display device 909, which may be also coupled to the data bus 904, for displaying various information to a user of the computerized system 100. In an alternative embodiment, the display 909 may be associated with a graphics controller and/or graphics processor (not shown). The display device 909 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 909 may be incorporated into the same general enclosure with the remaining components of the computerized system 100. In an alternative embodiment, the display device 909 may be positioned outside of such enclosure.

In one or more embodiments, the display device 909 may be implemented in a form of a projector or a mini-projector configured to project information on various objects, such as glasses worn by the user. In one or more embodiments, the display device 909 may be configured to be mountable on the head of the user. To this end, the display device 909 may be provided with suitable mounting hardware (not shown). The display device 909 may be used do display the calendar user interface described above.

In one or more embodiments, the computerized system 100 may further incorporate an audio playback device 918 connected to the data bus 904 and configured to play various audio files, such as MPEG-3 files, or audio tracks of various video files, such as MPEG-4 files, well known to persons of ordinary skill in the art. To this end, the computerized system 100 may also incorporate waive or sound processor or a similar device (not shown).

In one or more embodiments, the computerized system 100 may incorporate one or more input devices, such as a touchscreen interface 910 for receiving user's tactile commands, such as swiping gestures for controlling the calendar user interface described above, a camera 911 for acquiring still images and video of various objects, as well as a keyboard 906, which all may be coupled to the data bus 904 for communicating information, including, without limitation, images and video, as well as user command selections to the processor 901. In an alternative embodiment, input devices may include a system for tracking eye movements of the user (not shown), which may be used to indicate to the computerized system 100 the command selection made by the user.

In one or more embodiments, the computerized system 100 may additionally include a positioning and orientation module 903 configured to supply data on the current geographical position, spatial orientation as well as acceleration of the computerized system 100 to the processor 901 via the data bus 904. The geographical position information may be obtained by the positioning module 903 using, for example, global positioning system (GPS) technology and/or other positioning techniques such as by using information provided by proximate cell towers and/or WIFI hotspots. The acceleration data is supplied by one or more accelerometers incorporated into the positioning and orientation module 903. Finally, the orientation information may be obtained using acceleration measurements in all 3 axes, including the gravity. In one or more embodiments, the position, orientation and acceleration metadata provided by the positioning and orientation module 903 is continuously recorded and stored in the data storage unit 917.

In one or more embodiments, the computerized system 100 may additionally include a communication interface, such as a network interface 905 coupled to the data bus 904. The network interface 905 may be configured to establish a connection between the computerized system 100 and the Internet 919 using at least one of WIFI interface 907 and the cellular network (GSM or CDMA) adaptor 908. The network interface 905 may be configured to provide a two-way data communication between the computerized system 100 and the Internet 919. The WIFI interface 907 may operate in compliance with 802.11a, 802.11b, 802.11g and/or 802.11n protocols as well as Bluetooth protocol well known to persons of ordinary skill in the art. In an exemplary implementation, the WIFI interface 907 and the cellular network (GSM or CDMA) adaptor 908 send and receive electrical or electromagnetic signals that carry digital data streams representing various types of information.

In one or more embodiments, the Internet 919 typically provides data communication through one or more sub-networks to other network resources. Thus, the computerized system 100 is capable of accessing a variety of network resources located anywhere on the Internet 919, such as remote media servers, web servers, other content servers as well as other network data storage resources. In one or more embodiments, the computerized system 100 is configured send and receive messages, media and other data, including application program code, through a variety of network(s) including Internet 919 by means of the network interface 905. In the Internet example, when the computerized system 100 acts as a network client, it may request code or data for an application program executing on the computerized system 100. Similarly, it may send various data or computer code to other network resources.

In one or more embodiments, the functionality described herein is implemented by computerized system 100 in response to processor 901 executing one or more sequences of one or more instructions contained in the memory 912. Such instructions may be read into the memory 912 from another computer-readable medium. Execution of the sequences of instructions contained in the memory 912 causes the processor 901 to perform the various process steps described herein. In alternative embodiments, hard-wired circuitry may be used in place of or in combination with software instructions to implement the embodiments invention. Thus, embodiments of the invention are not limited to any specific combination of hardware circuitry and software.

The term “computer-readable medium” as used herein refers to any medium that participates in providing instructions to processor 901 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to processor 901 for execution. For example, the instructions may initially be carried on a magnetic disk from a remote computer. Alternatively, a remote computer can load the instructions into its dynamic memory and send the instructions over the Internet 919. Specifically, the computer instructions may be downloaded into the memory 912 of the computerized system 100 from the foresaid remote computer via the Internet 919 using a variety of network data communication protocols well known in the art.

In one or more embodiments, the memory 912 of the computerized system 100 may store any of the following software programs, applications or modules:

1. Operating system (OS) 913, which may be a mobile operating system for implementing basic system services and managing various hardware components of the computerized system 100. Exemplary embodiments of the operating system 913 are well known to persons of skill in the art, and may include Android, iOS, Microsoft Windows Mobile as well as any other now known or later developed mobile operating systems.

2. Mobile applications 914 may include, for example, a set of software applications executed by the processor 901 of the computerized system 100, which cause the computerized system 100 to perform certain predetermined functions, such as acquire digital images using the camera 911 or play media files using the display 909 and/or an audio playback device 918. In one or more embodiments, the applications 914 may include the calendar application 915 described above.

3. Data storage 916 may be used, for example, for storing the calendar events 917 displayed to the user using the described calendar user interface.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for automated generation of the graphical user interface incorporating a horizontally-oriented calendar described above. It is intended that the specification and examples be considered as exemplary only, with a true scope and spirit of the invention being indicated by the following claims.

What is claimed is:

1. A computer-implemented method for generating a calendar graphical user interface, the method being performed in connection with a computerized system comprising a processor, a memory and a display device, the method comprising:
a. generating a graphical user interface on the display device, the graphical user interface comprising a calendar portion, the calendar portion comprising a plurality of calendar date elements, wherein the plurality of calendar date elements are horizontally arranged on the display device and wherein at least some of the calendar date elements comprise a user availability indicator indicating an availability of a user during a corresponding day;
b. receiving information on a user interaction event in connection with the calendar portion of the user interface;
c. if the received information indicates that the user interaction event is a selection event performed in connection with a first calendar date element of the plurality of calendar date elements, displaying calendar events corresponding to the first calendar date element; and
d. if the received information indicates that the user interaction event is a vertical swipe gesture, generating a second graphical user interface comprising a second calendar portion, the second calendar portion comprising a second plurality of calendar date elements corresponding to a calendar month.

2. The computer-implemented method of claim 1, wherein the user availability indicator is color-coded based on the availability of the user during the corresponding day.

3. The computer-implemented method of claim 1, wherein the user availability indicator is color-coded with a color selected from a group consisting of: green, yellow and red colors.

4. The computer-implemented method of claim 1, wherein graphical user interface comprises an agenda portion and wherein the calendar events corresponding to the first calendar date element are displayed in the agenda portion.

5. The computer-implemented method of claim 4, further comprising, in response to detection of a scroll event in connection with the agenda portion, correspondingly scrolling the calendar date elements in the calendar portion.

6. The computer-implemented method of claim 1, wherein the calendar portion is positioned at the bottom of the graphical user interface.

7. The computer-implemented method of claim 1, wherein the calendar portion is semi-transparent.

8. The computer-implemented method of claim 1, wherein second graphical user interface further comprises a statistical portion comprising calendar event statistical information for the calendar month.

9. The computer-implemented method of claim 8, wherein the calendar event statistical information comprises information on numbers of calendar events of predetermined different types.

10. The computer-implemented method of claim 8, wherein the calendar event statistical information comprises information on numbers of calendar events on predetermined weekdays.

11. The computer-implemented method of claim 10, wherein the information on numbers of calendar events on predetermined weekdays comprises a plurality of color-coded bars.

12. A non-transitory computer-readable medium embodying a set of computer-readable instructions, which, when executed in connection with a computerized system comprising a processor, a memory and a display device, cause the computerized system to perform a method for generating a calendar graphical user interface, the method comprising:
a. generating a graphical user interface on the display device, the graphical user interface comprising a calendar portion, the calendar portion comprising a plurality of calendar date elements, wherein the plurality of calendar date elements are horizontally arranged on the display device and wherein at least some of the calendar date elements comprise a user availability indicator indicating an availability of a user during a corresponding day;
b. receiving information on a user interaction event in connection with the calendar portion of the user interface;
c. if the received information indicates that the user interaction event is a selection event performed in connection with a first calendar date element of the plurality of calendar date elements, displaying calendar events corresponding to the first calendar date element; and
d. if the received information indicates that the user interaction event is a vertical swipe gesture, generating a second graphical user interface comprising a second calendar portion, the second calendar portion comprising a second plurality of calendar date elements corresponding to a calendar month.

13. The non-transitory computer-readable medium of claim 12, wherein the user availability indicator is color-coded based on the availability of the user during the corresponding day.

14. The non-transitory computer-readable medium of claim 12, wherein the user availability indicator is color-coded with a color selected from a group consisting of: green, yellow and red colors.

15. The non-transitory computer-readable medium of claim 12, wherein graphical user interface comprises an agenda portion and wherein the calendar events corresponding to the first calendar date element are displayed in the agenda portion.

16. The non-transitory computer-readable medium of claim 15, wherein the method further comprises, in response to a detection of a scroll event in connection with the agenda portion, correspondingly scrolling the calendar date elements in the calendar portion.

17. The non-transitory computer-readable medium of claim 12, wherein the calendar portion is positioned at the bottom of the graphical user interface.

18. The non-transitory computer-readable medium of claim 12, wherein the calendar portion is semi-transparent.

19. The non-transitory computer-readable medium of claim 12, wherein second graphical user interface further comprises a statistical portion comprising calendar event statistical information for the calendar month.

20. A computerized system comprising a processor, a memory and a display device, the memory storing a set of computer-readable instructions, which, when executed by the processor cause the computerized system to perform a method for generating a calendar graphical user interface, the method comprising:
a. generating a graphical user interface on the display device, the graphical user interface comprising a calendar portion, the calendar portion comprising a plurality of calendar date elements, wherein the plurality of calendar date elements are horizontally arranged on the display device and wherein at least some of the calendar date elements comprise a user availability indicator indicating an availability of a user during a corresponding day;
b. receiving information on a user interaction event in connection with the calendar portion of the user interface;
c. if the received information indicates that the user interaction event is a selection event performed in connection with a first calendar date element of the plurality of calendar date elements, displaying calendar events corresponding to the first calendar date element; and
d. if the received information indicates that the user interaction event is a vertical swipe gesture, generating a second graphical user interface comprising a second calendar portion, the second calendar portion comprising a second plurality of calendar date elements corresponding to a calendar month.
